(19) United States
(12) Patent Application Publication
(10) Pub. No.: US 2022/0215383 A1
(43) Pub. Date: Jul. 7, 2022

(54) System and Method of receiving direct cryptocurrency transactions

(71) Applicant: Stanislav Kulyk, Lublin (PL)

(72) Inventor: Stanislav Kulyk, Lublin (PL)

(21) Appl. No.: 17/170,434

(22) Filed: Feb. 8, 2021

Related U.S. Application Data
(60) Provisional application No. 63/134,135, filed on Jan. 5, 2021.

(51) Int. Cl. G06Q 20/36; G06Q 20/06; G06Q 20/38; G05B 15/02

(52) U.S. Cl. CPC G06Q 20/3678; G06Q 20/0655; A61H 19/00; G05B 15/02; G06Q 2220/00; G06Q 20/389

(57) ABSTRACT

The present invention relates to a decentralization of remote interaction between a tipper and an adult toy by implementing a system and method of receiving direct cryptocurrency transactions, in online adult entertainment. The adult toy is integrated with its own cryptocurrency wallet which is able to receive direct cryptocurrency transactions on it. A special control software algorithm initialises proper mechanical activity of the adult toy based on the amount of cryptocurrency received. The cryptography basis of the cryptocurrencies ensures that IP address or any other identification data of the adult toy in the internet will be known only to its owner. Therefore, the privacy and security of the end users and the webcam models of the online adult entertainment industry is maintained.

### FIELD OF THE INVENTION

The present invention relates primarily to a remote interaction in online adult entertainment industry and more particularly it relates to a decentralization of remote interaction between a tipper and an adult toy by implementing a system and method of receiving direct cryptocurrency transactions.

### BACKGROUND OF THE INVENTION

There is an online adult entertainment industry, created for people who like to fulfil their erotic desires by watching webcam model shows via special video streaming websites or mobile applications. During that shows, watcher or tipper can send a tip to webcam model whose show he enjoys through streaming platform payment system, using his credit card. To make their shows more interesting, webcam models often use adult toys.

Nowadays, adult toys can be connected to the internet and accept external API requests to be remotely controlled. Those features give an option for streaming platform system to take a control over webcam model's adult toy via internet connection and activate it, automatically, once any tip occurs.

The streaming platform system, which represents abovementioned method, generally consists of two major components. The first component is a website which plays video streams to end users or tippers and maintains payments. The second one is an API server, which operates adult toys connected to it.

The prior art document U.S. Pat. No. 9,762,515B1 discloses the same kind of system as mentioned in above paragraph. The document discloses a system and method for allowing one or more users to interact with models from a distance by enabling the users to tip the models during online video chat sessions. The adult toy can be Wi-Fi or Bluetooth™ enabled to receive commands directly from the server via a web browser extension, the website hosting an online video chat session, or connect to an application installed on a device operated by the model, wherein the application communicates with the web browser extension to relay commands to the adult toy.

Due to centralised nature of remote adult toy activation method inherent in the prior arts, there are a few disadvantages exists. It is possible that money assets of tippers and webcam models can be stolen from streaming platform, by its owners or hackers. Moreover, hackers can intercept remote control over the adult toy by sending fake API requests to it. Also, streaming platform can easily collect hidden usage and private data of adult toy and its owner.

Therefore, there is a significant need and void in the online adult entertainment industry for inventing a system and method to decentralize the whole way of communication between tipper and the remote controlled adult toy device by excluding any remote control APIs from it.

### SUMMARY OF THE INVENTION

The present invention is related to a decentralization of the remote interaction between a tipper and an adult toy which addresses the needs which were not fulfilled by the conventional arts. The system and method of the present invention discloses a decentralised way of remote interaction between a tipper and a webcam model's adult toy, based on an integration of a cryptocurrency wallet component to it and an algorithm transforming transaction data into mechanical activity. The present invention renders exclusion of any streaming platform remote control APIs and payment systems.

Like a serial number which has any electronic device, there is a cryptocurrency wallet address assigned to the adult toys used in the interactive online adult entertainment. This makes them able to receive direct cryptocurrency transactions and then perform self-activation. Due to the self-activation, the adult toys will not use any remote APIs and therefore become almost impossible to be hacked. The cryptography basis of the cryptocurrencies ensures that IP address or any other identification data of the adult toy in the internet will be known only to its owner.

The cryptocurrency wallet address will be shared to the public only. It is extremely hard to perform hacking of the adult toy's cryptocurrency wallet, having just that one parameter. The money assets of tippers and webcam models cannot be stolen from streaming platform, because they will be kept on their personal cryptocurrency wallets. Since the cryptocurrency transactions are transferred directly to the adult toys, passing streaming platform servers, the later cannot collect any hidden usage or private statistics data.

The decentralised system and method of present invention provides multifold benefits to the end users and the webcam models of the online adult entertainment industry which are described in the following pages of specification.

### BRIEF DESCRIPTION OF DRAWINGS

Other objects, advantages and novel features of the invention will become apparent from the following detailed description of the present embodiment when taken in conjunction with the accompanying drawings. These figures are not intended to limit the scope of the present invention but rather illustrate certain attributes thereof.

FIG. 1 is a block diagram showing system and method for remote interaction between a tipper and an adult toy according to an embodiment of the present invention.

FIG. 2 is a block diagram showing an adult toy control software system with cryptocurrency wallet and other components working together according to an embodiment of the present invention.

FIG. 3 is a flow chart showing a software algorithm for method of transformation of cryptocurrency transaction data into mechanical activity according to an embodiment of the present invention.

FIG. 4 is a tabular chart showing the data of database used by adult toy control software according to an embodiment of the present invention.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION OF THE INVENTION

The foregoing disclosure has broadly outlined the features and technical advantages of the present disclosure in order that the description of the disclosure that follows may be better understood. It should be appreciated by those skilled in the art that the conception and specific embodiment disclosed may be readily utilized as a basis for modifying or designing other structures for carrying out the same purposes of the present disclosure. The novel features which are believed to be characteristic of the disclosure, both as to its organization and method of operation, together with further objects and advantages will be better understood from the following description.

Before explaining the present invention in detail, it is to be understood that the invention is not limited in its application to the details of the construction and arrangement of parts illustrated in the accompanying drawings. The invention is capable of other embodiments, as depicted in different figures as described above and of being practiced or carried out in a variety of ways. It is to be understood that the phraseology and terminology employed herein is for the purpose of description and not of limitation.

It is to be understood that the term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also contain one or more other components.

It is to be understood that the terms “tipper”, “watcher”, “end user” or “donator” used in this application are interchangeable.

It is to be understood that the term “server” refers to server-type computer, connected to the internet.

It is to be understood that the term “device” used in this application refers to laptop, smartphone, tablet, smartwatch, personal or server-type computer, connected to the internet.

It is to be understood that the terms “webcam model”, and “owner” or “adult toy owner” are interchangeable.

It is to be understood that the term “API” is an abbreviation of application programming interface.

It is to be understood that the term “adult toy” refers to any kind of electronic device intended for providing a sexual satisfaction to its user, i.e. a spanking machine, a vibrator, an electronic masturbator etc.

It is to be understood that the term “mechanical activity” refers to physical actions performed by adult toy's hardware with specified parameters such as working time, speed, movement type, power level etc. Those parameters may vary depending on type of an adult toy.

Reference will now be made in detail to a presently preferred embodiment of the invention, an example of which is illustrated in the accompanying drawings.

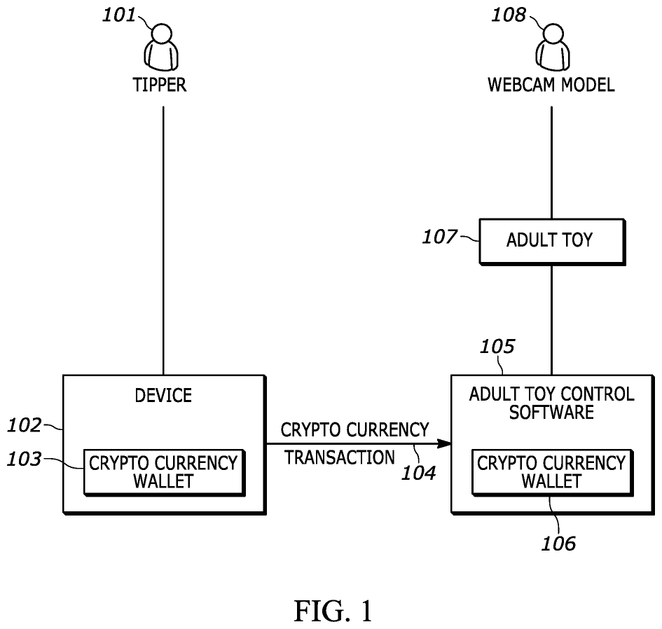

Referring to FIG. 1, according to an embodiment of the present invention, a system of receiving direct cryptocurrency transactions comprises: a tipper (101) who has a device (102) with a running cryptocurrency wallet (103) on it. A webcam model (108) who has an adult toy (107) with a cryptocurrency wallet (106) integrated to its control software system (105). The control software system (105) can fully operate on a built-in microprocessor of the adult toy (107) or on separate device working in pair with the adult toy (107) via Wi-Fi, Bluetooth or internet connection. To remotely interact with the adult toy (107) of the webcam model (108), the tipper (101) makes a direct cryptocurrency transaction (104) with special amount to the integrated cryptocurrency wallet (106) of the adult toy (107) of the webcam model (108).

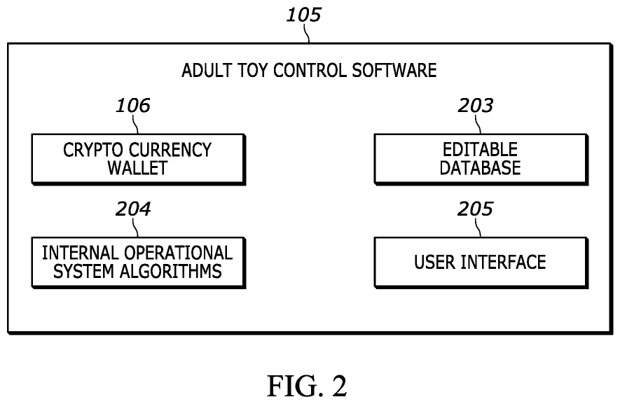

Now referring to FIG. 2, according to an embodiment of the present invention, the control software system (105) comprises the cryptocurrency wallet (106), an editable database (203), an internal operational software algorithm (204) and a user interface (205) components. The cryptocurrency wallet (106) is a component which makes a synchronisation with cryptocurrency blockchain network, generates and assigns unique cryptocurrency wallet address to the adult toy (107), constantly tracks any incoming transactions in real-time, and stores cryptocurrency assets received from the tipper (101). The editable database (203) is a component storing mechanical activity parameters predefined by the owner (108) of the adult toy (107), in relation to the amount of cryptocurrency transaction received.

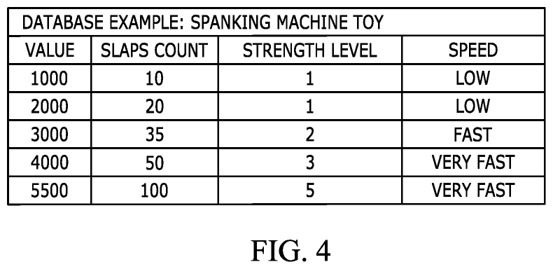

Furthermore, an exemplary structure and data of the editable database (203) for an automatic spanking machine adult toy is shown in FIG. 4. Once the spanking machine detects an incoming transaction in the amount of 4000 cryptocurrency tokens, it starts slapping the webcam model 50 times, with 3rd level of impact strength and in very fast speed.

Moreover, the user interface (205) is a component which allows the webcam model (108) to interact with the adult toy control software (105), e.g. enter data to the editable database (203), and withdraw cryptocurrency assets from the cryptocurrency wallet (106). The internal operational system algorithm (204) is a component containing basic operational system algorithms and the algorithm which transforms the incoming tip transaction data into the appropriate hardware mechanical activity.

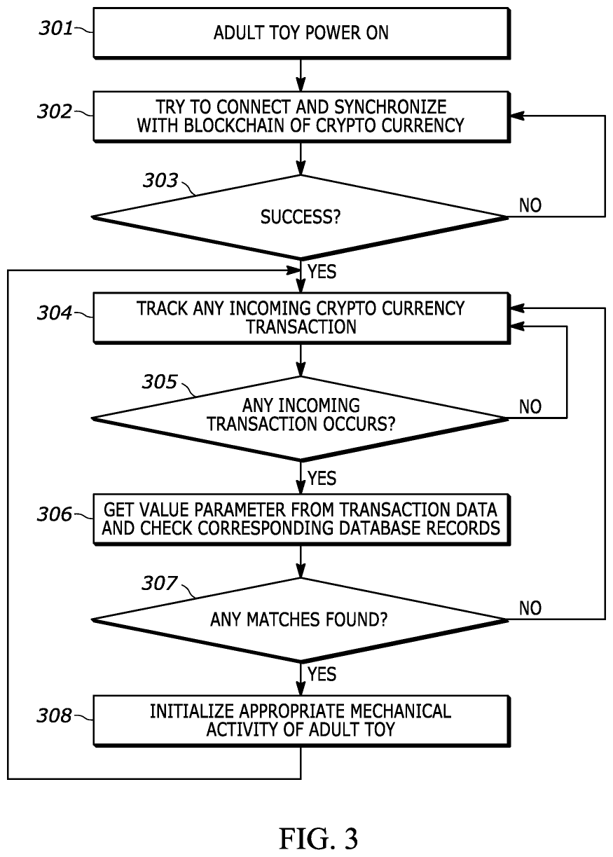

The objective of the present invention will become apparent from the following description of the sequential steps represented by the flow diagrams of the present invention. Referring to FIG. 3, the key steps of transformation of cryptocurrency transaction data into mechanical activity is shown according to an exemplary embodiment of the present invention. In FIG. 3, at an input step 301 starting with the process, the adult toy (107) powers on. After that, at step 302, the cryptocurrency wallet (106) component of the control software system (105) tries to connect and synchronize with blockchain of cryptocurrency.

At step 303, if the connection of the cryptocurrency wallet (106) with blockchain is not successful, then the system of the present invention has to follow the previous step 302, wherein the cryptocurrency wallet (106) tries to connect and synchronize with blockchain of cryptocurrency. If the connection of the cryptocurrency wallet (106) with blockchain is successful, then the system can proceed towards further steps of the present invention.

At further step 304, the cryptocurrency wallet (106) starts to track any incoming cryptocurrency transaction. At step 305, if the incoming cryptocurrency transaction cannot be tracked, then the system of the present invention has to follow the previous step 304. If the incoming cryptocurrency transaction is being tracked, then the system can proceed towards further steps of the present invention.

At step 306, once any incoming transaction occurs, one of the internal operational system algorithms (204) will get value parameter from transaction dataset and check corresponding database records.

At step 307, if any matches are found in the database records, then the system can proceed towards further steps of the present invention. And if the matches are not found in the database records, then the system of the present invention has to follow the previous step 306.

Once the match is found, proceeding towards further step 308, the internal operational system algorithms (204) will initialize the appropriate mechanical activity of the adult toy (107).

The system and method of present invention is advantageous over the conventional interactive online entertainment system and method. The remote interaction system of the present invention solves the existing problems by decentralizing the whole way of communication between the tipper and the remote controlled adult toy device by excluding any remote control APIs from it. By doing this, the money assets of the tippers and webcam models cannot be stolen from streaming platform, because they will be kept on their personal cryptocurrency wallets. Since the cryptocurrency tips are transferred directly to the adult toys, the streaming platform servers cannot collect any hidden usage or private statistics data. This way, the decentralised system and method of present invention provides privacy and security to the end users and webcam models of the online adult entertainment industry.

The above embodiments are described generally in terms of hardware and software. It will be recognized, however, that the functionality of the hardware can be further combined or even separated.

The functionality of the software can also be further combined or even separated. Hardware can be replaced, at times, with software. Software can be replaced, at times, with hardware. Accordingly, the present embodiments should not be construed as limiting the scope of the claims here. One of ordinary skill in the art would recognize other variations, modifications, and alternatives. It is inferred that the foregoing description is only illustrative of the present invention and it is not intended that the invention be limited or restrictive thereto. Many other specific embodiments of the present invention will be apparent to one skilled in the art from the foregoing disclosure. All substitution, alterations and modification of the present invention which come within the scope of the following claims are to which the present invention is readily susceptible without departing from the spirit of the invention. The scope of the invention should therefore be determined not with reference to the above description but should be determined with reference to appended claims along with full scope of equivalents to which such claims are entitled.

### LIST OF REFERENCE NUMERALS

101 tipper
102 tipper's device
103 tipper's cryptocurrency wallet
104 cryptocurrency transaction
105 control software system
106 adult toy's cryptocurrency wallet
107 adult toy
108 webcam model
203 editable database
204 internal operational software algorithm
205 user interface

I claim:

1. A system of receiving direct cryptocurrency transactions, comprising:
an adult toy (107), with a cryptocurrency wallet (106) integrated to its control software system (105), said cryptocurrency wallet (106) configured to:
synchronise with cryptocurrency blockchain network;
generate and assign unique cryptocurrency wallet address to the adult toy (107);
track an incoming cryptocurrency transactions in real-time; and
store the cryptocurrency transactions received from the tipper.

2. The system of receiving direct cryptocurrency transactions according to claim 1, wherein the control software system (105) running on a separate device working in pair with the adult toy (107) via Wi-Fi, Bluetooth or internet connection.

3. The system of receiving direct cryptocurrency transactions according to claim 1, wherein the control software system (105) comprises an editable database (203), an internal operational software algorithm (204), and a user interface (205).

4. The system of receiving direct cryptocurrency transactions according to claim 3, wherein the editable database (203) is configured to store mechanical activity parameters predefined by an owner (108) of the adult toy (107), in relation to the amount of cryptocurrency transaction received.

5. The system of receiving direct cryptocurrency transactions according to claim 3, wherein the user interface (205) is configured to allow the owner (108) to interact with the adult toy control software (105).

6. The system of receiving direct cryptocurrency transactions according to claim 3, wherein the internal operational system algorithm (204) is configured to transform the incoming tip transaction data into the appropriate hardware mechanical activity.

7. A method of receiving direct cryptocurrency transactions, comprising the steps of:
connecting and synchronizing a cryptocurrency wallet (106) with blockchain of cryptocurrency;
tracking and receiving an incoming cryptocurrency transaction by the cryptocurrency wallet (106);
extracting value parameter from transaction dataset by an internal operational system algorithms (204);
checking special database for any record corresponding with transaction value parameter by the internal operational system algorithms (204); and
initializing adult toy hardware mechanical activity with parameters, if any record found.
